(19) United States
(12) Patent Application Publication
(10) Pub. No.: US 2012/0236393 A1
(43) Pub. Date: Sep. 20, 2012

(54) SPD FILMS FORMED WITH CONDUCTIVE POLYMER-COATED SUBSTRATES

(75) Inventors: Steven M. Slovak, N. Massapequa, NY (US); Xiao-Ping Chen, East Meadow, NY (US); William J. Hull, Bayside, NY (US); Dongyan Wang, Ithaca, NY (US)

(73) Assignee: RESEARCH FRONTIERS INCORPORATED, Woodbury, NY (US)

(21) Appl. No.: 13/464,173

(22) Filed: May 4, 2012

(51) Int. Cl. G02F 1/167; B32B 37/12; B05D 5/12

(52) U.S. Cl. 359/296; 427/58; 156/60; 427/108

(57) ABSTRACT

A suspended particle device (SPD) film or laminate thereof. The film includes substrates coated on their inner surface with a polythiophene-based conductive polymer serving as electrode means. The polymer may be applied in the form of an aqueous composition also comprising solvent(s) and binder(s). A preferred polymer is a polyethylene dioxythiophene (PEDT) polymer. The polymer may be doped with polystyrene sulfonate. The polymer may be connected to a conductive material that extends beyond an outer boundary of the film to connect with a voltage source. Adhesive strength between the cured emulsion and the polymer is at least 1.46 N/25 mm. A further aspect constitutes a method for increasing adhesion between a cured suspended particle device emulsion and electrode means in a light valve film. The method comprises applying the polymer on an inner surface of the substrates constituting the film to serve as the electrode means.

### FIELD OF THE INVENTION

The invention is generally directed to suspended particle devices, commonly referred to as SPD light valves or simply as SPDs. The devices comprise films or laminates of such films, which serve as the light-modulating element. The invention is more particularly directed to films/laminates as described and claimed herein formed with conductive polymer coated substrates serving as the electrodes instead of conventional indium tin oxide (“ITO”) electrodes.

### BACKGROUND OF THE INVENTION

SPD light valves have been used for more than seventy years for modulating light. The devices have been proposed for use in numerous applications during that time including, but not limited to, alphanumeric displays and television displays; filters for lamps, cameras, displays and optical fibers; and windows, sunroofs, toys, sunvisors, eyeglasses, goggles, mirrors, light pipes and the like, to control the amount of light passing therethrough or reflected therefrom as the case may be. Examples of windows including such light valves include, without limitation, architectural windows for commercial buildings, greenhouses and residences, windows, visors and sunroofs for automotive vehicles, boats, trains, planes and spacecraft, windows for doors including peepholes, and windows for appliances such as ovens and refrigerators including compartments thereof.

As used herein, the term, “light valve” describes a cell formed of two walls that are spaced apart by a small distance, with at least one said wall being transparent. The walls have electrodes thereon, usually in the form of transparent, electrically conductive coatings. The electrically conductive coatings can be deposited on the walls in patterns so that different segments of the light valve can be selectively activated. Additionally the electrodes on the walls may have thin transparent dielectric overcoatings thereon. Light valves comprise, as a light-modulating element (sometimes herein referred to as an activatable material) either a liquid suspension of particles, or a plastic film constituting a cured emulsion in which droplets of a liquid suspension of particles are distributed, wherein the light-modulating element is located between the cell walls.

The liquid suspension (sometimes referred to as a liquid light valve suspension or simply a light valve suspension) comprises small particles suspended in a liquid suspending medium. In the absence of an applied electrical field, the particles in the liquid suspension assume random positions due to Brownian movement. Hence, a beam of light passing into the cell is reflected, transmitted or absorbed depending upon the cell structure, the nature and concentration of the particles and the energy content of the light. The light valve is thus relatively dark in the OFF state. However, when an electric field is applied through the liquid light valve suspension in the light valve, the particles become aligned and for many suspensions most of the light can pass through the cell. The light valve is thus relatively transparent in the ON state. The ΔT is defined as the difference in visible light transmission between the ON and OFF states.

For many applications it is preferable for all or part of the activatable material, i.e., the light modulating element, to be a plastic film rather than a liquid suspension. For example, in a light valve used as a variable light transmission window, a plastic film in which droplets of liquid suspension are distributed is preferable to a liquid suspension because hydrostatic pressure effects, e.g., bulging, associated with a high column of light suspension, can be avoided through use of a film and the risk of possible leakage can also be avoided. Another advantage of using a plastic film is that, in such film the particles are generally present only within very small droplets and, hence, do not noticeably agglomerate when the film is repeatedly activated with a voltage.

A light valve film (sometimes referred to herein as an SPD film) comprises, as described above, inter alia, a cured emulsion constituting a suspension of particles used or intended for use in an SPD light valve. The cured emulsion comprises a discontinuous droplet phase of a liquid or liquids comprising dispersed particles (liquid light valve suspension), such discontinuous phase being dispersed throughout a solid continuous polymeric matrix phase. The cured SPD emulsion is enclosed within one or more rigid or flexible solid sheets (commonly referred to as substrates). The material used in forming the sheets may offer, depending upon the particular material chosen, a variety of useful properties, including (1) scratch resistance, (2) protection from ultraviolet radiation, (3) reflection of infrared energy, (4) electrical conductivity for transmitting an applied electric or magnetic field to the cured emulsion, and (5) dielectric properties.

The light valve film may additionally comprise one or more additional layers such as, without limitation, a film, coating or sheet or combination thereof, laminated upon an outer surface of the film, i.e., referred to herein as a light valve laminate, which may provide the light valve film with one or more of, for example, (1) scratch resistance, (2) protection from ultraviolet radiation, (3) reflection of infrared energy, (4) color tinting, and (5) acoustic control.

A common (non-limiting) construction for an SPD film is a stack comprising five layers, namely, from one opposed side to the other: (1) a first sheet of polyethylene terephthalate (“PET”) plastic, conveniently 5-7 mils in thickness, (2) a very thin transparent, electrically conductive coating of indium tin oxide (“ITO”), acting or capable of acting as an electrode, on an inner surface of the first sheet of PET, (3) a layer of cured (i.e., cross-linked) SPD emulsion, usually 2-5 mils in thickness and, (4) a second ITO coating acting or capable of acting as an electrode on an inner surface of (5) a second PET plastic substrate. As stated above, moreover, additional layers providing other functions may optionally be laminated to the five-layer SPD film exemplified herein. Typically, copper foil, conductive fabric or the like are affixed to the electrodes so that they extend beyond the perimeter of the SPD film for convenient connection to a suitable voltage source. Furthermore the SPD film can be laminated, for example, with transparent hot melt adhesive films and/or glass or thicker transparent plastic sheets to provide strength and rigidity and to protect various parts of the combined unit from environmental stresses which may, otherwise, damage its performance characteristics.

U.S. Pat. No. 5,409,734 exemplifies a type of non-cross-linked light valve film that is made by phase separation from a homogeneous solution. Alternate types of light valve films, i.e., made by cross-linking (curing) of emulsions are also known. The light modulating elements used in the present invention constitute the latter type of film, i.e., film comprising a layer formed by cross-linking an emulsion, and laminated films produced therewith. See, for example, U.S. Pat. Nos. 5,463,491 and 5,463,492, and 7,361,252, all of which are assigned to the assignee of the present invention. Various types of SPD emulsions and methods of curing these emulsions are described in U.S. Pat. Nos. 6,301,040, 6,416,827, and 6,900,923 B2, which are all also assigned to the assignee of the present invention. Such films and variants thereof may be cured through cross-linking brought about by exposing the films to (1) ultraviolet radiation, (2) electron beams and/or (3) heat. All of the patents and other references cited herein are incorporated by reference.

A variety of liquid light valve suspensions are well known in the art and such suspensions are readily formulated according to techniques well known to one of ordinary skill therein. The term liquid light valve suspension, as noted above, when used in the present context means a liquid suspending medium in which a plurality of small particles are dispersed. The liquid suspending medium comprises one or more non-aqueous, electrically resistive liquids in which there is preferably dissolved at least one type of polymeric stabilizer that acts to reduce the tendency of the particles to agglomerate and to keep them dispersed and in suspension.

Liquid light valve suspensions useful in the present invention may include any of the so-called prior art liquid suspending media previously proposed for use in light valves for suspending the particles. Liquid suspending media known in the art which are useful herein include, but are not limited to, the liquid suspending media disclosed in U.S. Pat. Nos. 4,247,175, 4,407,565, 4,772,103, 5,409,734, 5,461,506, 5,463,492, and 6,936,193 B2, the disclosures of which are incorporated herein by reference. In general one or both of the suspending medium or the polymeric stabilizer typically dissolved therein is chosen so as to maintain the suspended particles in gravitational equilibrium.

The polymeric stabilizer, when employed, can be a single type of solid polymer that bonds to the surface of the particles, but which also dissolves in the non-aqueous liquid(s) which comprise the liquid suspending medium. Alternatively, there may be two or more solid polymeric stabilizers serving as a polymeric stabilizer system. For example, the particles can be coated with a first type of solid polymeric stabilizer such as nitrocellulose which, in effect, when dissolved provides a plain surface coating for the particles, together with one or more additional types of solid polymeric stabilizer that when dissolved, bond to or associate with the first type of solid polymeric stabilizer and also dissolve in the liquid suspending medium to provide dispersion and steric protection for the particles. Also, liquid polymeric stabilizers may be used to advantage, especially in SPD light valve films, as described for example in U.S. Pat. No. 5,463,492.

Particles used in a light valve suspension may be organic or inorganic and such particles may be either light absorbing or light reflecting in the visible portion of the electromagnetic spectrum.

Conventional SPD light valves have generally employed particles of colloidal size. As used herein the term colloidal means that the particles generally have a largest dimension averaging 1 micron or less. Preferably, most polyhalide or non-polyhalide types of particles used or intended for use in an SPD light valve suspension will have a largest dimension which averages 0.3 micron or less and more preferably averages less than one-half of the wavelength of blue light, i.e., less than 2000 Angstroms, to keep light scatter extremely low.

Prior art SPD films have typically been formed with a very thin transparent, electrically conductive coating of indium tin oxide (“ITO”) on the inner aspect of the substrates “sandwiching” the cured emulsion, which coating acts or is capable of acting as an electrode. The ITO conductive coatings are typically highly transmissive (>85% visible light transmission) and are compatible with the cured SPD emulsion.

### Deficiencies of Prior Art SPD Films and SPD Laminates

As mentioned above, ITO has historically been utilized as the transparent conductive coating for SPD films. However, ITO-coated PET substrates can be very expensive and two such substrates are required to sandwich the cured emulsion component of an SPD film. In addition, the weak adhesion of the cured SPD emulsion to the ITO coated on the substrates can lead to separation of the substrates from the cured emulsion during, for example, the process of busbar application to the SPD film; in the lamination process where the SPD film is encapsulated between rigid glass or plastic substrates by melting plastic interlayers at elevated temperatures under vacuum; and pursuant to extended use of the suspended particle device.

Furthermore, the ITO coating is somewhat brittle and does not have the same flexibility as the PET substrate on which the ITO is coated. Therefore, excessive bending of the ITO-coated PET substrates of the SPD film can lead to breaks in the ITO layer that will cause partial or complete loss of conductivity of the SPD film when the voltage is applied.

### SUMMARY OF THE INVENTION

This invention enables the production of novel SPD films that incorporate transparent, conductive polymer coated substrates instead of traditional ITO coated substrates. The conductive polymer coatings have relatively high transparency compared to ITO coated substrates and are compatible with the SPD emulsion so the resulting SPD films maintain their optical characteristics including unpowered transmittance (T off), powered transmittance (T on) and light transmission range (ΔT). The conductive polymer coatings also impart greater flexibility and improved handling properties to the SPD films made from said coatings as well as increased adhesion to the cured SPD emulsion compared to prior art SPD films made with ITO coatings.

In one aspect the invention constitutes a suspended particle device (SPD) film, the film comprising a pair of opposed, spaced apart cell walls, a cured emulsion between the cell walls, and electrode means located upon at least a portion of an interior surface of both said cell walls, said cured emulsion having droplets of a liquid light valve suspension, with a plurality of particles dispersed in the liquid suspending medium, distributed within a cured polymer matrix material. The electrode means comprises a substantially transparent coating upon the cell wall(s), wherein the coating is constituted of a composition comprising a polythiophene-based conductive polymer. Furthermore, an adhesion value of adhesive strength between the cured emulsion and the coating is at least 1.46 N/25 mm.

A further aspect is directed to a method for increasing adhesion between a cured suspended particle device emulsion and electrode means in a light valve film. The film comprises a pair of spaced apart cell walls; a cured matrix polymer material between the cell walls and electrode means located upon at least a portion of an interior surface of both cell walls. The cured matrix polymer material has droplets of a liquid light valve suspension comprising a plurality of particles dispersed in the liquid suspending medium distributed within the matrix. The method comprises providing as the electrode means a substantially transparent coating upon at least a portion of each cell wall wherein the coating is constituted of a composition comprising a polythiophene-based conductive polymer.

### BRIEF DESCRIPTION OF THE DRAWING

FIG. 1 is an exploded view of an SPD film comprising transparent, conductive polymer coated substrates wherein the polymer is a polythiophene-based conductive polymer.

### DETAILED DESCRIPTION OF THE INVENTION

The increased demand for transparent conductive coatings for touch panels, smartphones, smart windows, etc., coupled with the current shortage of indium, has lead to higher pricing for ITO conductively coated substrates. The inventors herein have identified and tested several transparent conductive electrodes as alternatives to ITO. The possible alternatives have included carbon nanotubes (CNT's), other metal oxide coatings similar to ITO and nano-silver coatings. However, the ΔT values of the resulting SPD films produced with such coatings on PET substrates were significantly reduced in comparison what would be achieved with the use of ITO.

United States Patent Application Publication No. 2012/0034453 A1, assigned on its face to SKC CO., LTD, describes a conductive polymer layer formed on a substrate. The conductive layer is a polymer layer formed using a polythiophene-based conductive polymer composition comprising an aqueous solution of a polythiophene-based conductive polymer, an alcohol organic solvent, an amide organic solvent, or an aprotic highly dipolar solvent and a binder selected from melamine resin, polyester, polyurethane, polyacryl resin and alkoxysilane. In a preferred embodiment, the aqueous solution of the polythiophene-based conductive polymer may be polyethylene dioxythiophene (PEDT) that may be doped with polystyrene sulfonate. The substrate upon which the conductive polymer is applied would typically (but would not necessarily) be, in the case of suspended particle device films according to the present invention, a plastic such as polyethylene terephthalate (PET).

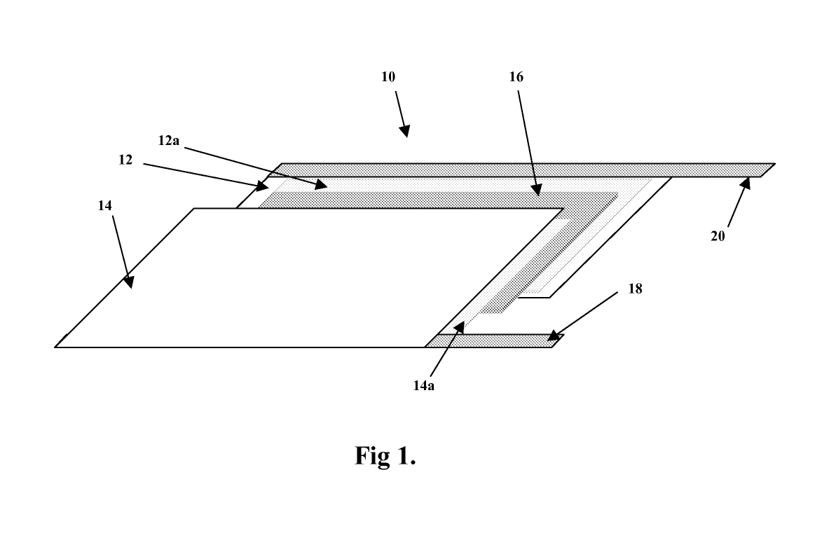

Referring to FIG. 1, there is shown an SPD film 10 comprising transparent, conductive polymer-coated substrates, wherein the conductive polymer is a polythiophene-based conductive polymer manufactured by SKC Company Ltd. The opposed, spaced-apart cell walls are shown at 12, 14. Located upon an interior aspect of at least a portion of cell walls 12, 14 is a polythiophene-based conductive polymer coating 12a, 14a. The SPD cured emulsion 16 is shown between cell walls 12, 14. Further, copper bus bars 18, 20, electrically connected to the respective polymer coatings, extend beyond the outer boundary of the film for connection with a suitable voltage source to provide power to the device.

Thus as indicated above, one embodiment of the invention constitutes a suspended particle device film, the film constituting a pair of opposed, spaced apart cell walls, a cured matrix polymer between the cell walls, and electrode means located upon at least a portion of an interior surface of both said cell walls, the cured matrix polymer material having droplets of a liquid light valve suspension comprising a plurality of particles dispersed in the liquid suspending medium, distributed within the matrix. The electrode means comprises a substantially transparent coating upon the cell wall(s), wherein the coating is constituted of a composition comprising a polythiophene-based conductive polymer. The polymer is preferably a polyethylene dioxythiophene (PEDT) polymer. In another embodiment the polymer is doped with polystyrene sulfonate. In a particular embodiment the cell walls may be made from glass, plastic or a glass-plastic laminate.

The coating composition may comprise, in addition to the polymer, at least one solvent and at least one binder. The at least one solvent may be, but is not necessarily, selected from the group consisting of an alcohol organic solvent, an amide organic solvent and an aprotic dipolar solvent. In a likewise manner, the at least one binder may be, but is not necessarily, selected from the group consisting of melamine resin, polyester, polyurethane, polyacryl resin and alkoxysilane.

In a particular embodiment the film comprises, in order:

(a) a first sheet of polyethylene terephthalate plastic;

(b) a first substantially transparent coating of said polythiophene-based conductive polymer upon at least a portion of an inner surface of said first sheet of polyethylene terephthalate plastic;

(c) a layer of cured SPD emulsion;

(d) a second substantially transparent coating of said polythiophene-based conductive polymer upon at least a portion of an inner surface of a second sheet of polyethylene terephthalate plastic; and

(e) a second sheet of polyethylene terephthalate plastic.

In another embodiment the film may be laminated, on its outer surfaces, with at least one selected from the group consisting of adhesive film, glass and a thicker transparent plastic sheet.

In a further embodiment a conductive material is connected to the electrode means of the film such that the conductive material extends beyond an outer boundary of the film for connection to a suitable voltage source.

In a still further embodiment the film is produced in the form of a window with the electrode means and cell walls being transparent.

An alternate embodiment of the invention involves, as indicated above, a method for increasing adhesion between a cured suspended particle device emulsion and electrode means in a light valve film wherein the film comprises a pair of spaced apart cell walls, a cured matrix polymer material between the cell walls and electrode means located upon at least a portion of an interior surface of both said cell walls, the cured matrix polymer material having droplets of a liquid light valve suspension comprising a plurality of particles dispersed in the liquid suspending medium distributed within the matrix. The method comprises providing, as the electrode means, a substantially transparent coating upon at least a portion of each cell wall, the coating constituted of a composition comprising a polythiophene-based conductive polymer.

As in the case of the embodiments described above, the polymer is preferably a polyethylene dioxythiophene (PEDT) polymer. In another embodiment the polymer is doped with polystyrene sulfonate. In a particular embodiment the cell walls may be made from glass, plastic or a glass-plastic laminate.

In other embodiments the coating composition may comprise, in addition to the polymer, at least one solvent and at least one binder. The at least one solvent may be, but is not necessarily, selected from the group consisting of an alcohol organic solvent, an amide organic solvent and an aprotic dipolar solvent. In a likewise manner, the at least one binder may be, but is not necessarily, selected from the group consisting of melamine resin, polyester, polyurethane, polyacryl resin and alkoxysilane.

In a particular embodiment the film comprises, in order:

(a) a first sheet of polyethylene terephthalate plastic;

(b) a first substantially transparent coating of said polythiophene-based conductive polymer upon at least a portion of an inner surface of said first sheet of polyethylene terephthalate plastic;

(c) a layer of cured SPD emulsion;

(d) a second substantially transparent coating of said polythiophene-based conductive polymer upon at least a portion of an inner surface of a second sheet of polyethylene terephthalate plastic; and

(e) a second sheet of polyethylene terephthalate plastic.

In another embodiment the film may be laminated, on its outer surfaces, with at least one selected from the group consisting of adhesive film, glass and a thicker transparent plastic sheet.

In a further embodiment a conductive material is connected to the electrode means of the film such that the conductive material extends beyond an outer boundary of the film for connection to a suitable voltage source.

In a still further embodiment the light valve film is produced in the form of a window with the electrode means and cell walls being transparent.

Samples of conductive PEDT polymer-coated PET substrates made by SKC Industries (Seoul, South Korea) were obtained and used to prepare SPD films per the description above of how such films are constituted. The inventors prepared all of the examples in the Table 1 below in the same manner, with a 4-mil SPD emulsion thickness and identical UV curing conditions. The composition of the SPD emulsion used in forming each of the examples mentioned below was as follows: (a) a crosslinkable dimethyldiphenylsiloxane continuous matrix phase (60%); (b) a methacrylate/trimellitate liquid suspending droplet phase (37.27%); and (c) polyiodide particles (2.73%). The optical characteristics of SPD films formed with substrates coated with several PEDT-based conductive polymers are set forth below and compared with the optical characteristics of a standard SPD film made with ITO coated substrates used as a control. The identifiers CLE 1, CLE 2 and CTR4C-KB10 are internal designations supplied by SKC Industries.

TABLE 1

| Substrate ID | T_{off} | Tₒₙ | ΔT |
|---|---|---|---|
| Control: ITO Coated (7 mil PET, Resistivity = | 1.33 | 49.47 | 48.14 |
| 300 Ω/square) | | | |
| 1) Coated With CLE1 (7 mil PET, Resistivity = | 2.18 | 45.98 | 43.80 |
| 150 Ω/square) | | | |
| 2) Coated With CLE2 (5 mil PET, Resistivity = | 1.60 | 51.42 | 49.82 |
| 250 Ω/square) | | | |
| 3) Coated With CTR4C-KB10 | 1.97 | 45.36 | 43.39 |
| (5 mil PET, Resistivity = 400 Ω/square) | | | |

The values set forth in Table 1 demonstrate that compared to the control SPD film formed with ITO-coated substrates, all three of the PEDT polymer-coated substrates have similar optical properties. The thickness of the PET substrate used in forming the various exemplary films for the testing described herein was chosen for convenience. The differences in thickness do not significantly affect the optical properties of the resulting SPD film. Furthermore, it was found that the SPD film comprising the substrate coated with the SKC polymer designated CLE2 is the best candidate, having a ΔT greater than the control SPD film comprising an ITO coating.

Further to the above, an important property of an SPD film is the degree of adhesion of the cured SPD emulsion to the conductive coating on the substrates that sandwich the emulsion. A strong adhesive bond between the cured emulsion and substrates is required because handling steps to apply bus bars to the SPD film and subsequent lamination of the SPD film between two glass or rigid plastic sheets with hot melt interlayers at elevated temperatures and pressure can cause the cured SPD emulsion to separate from the substrates. U.S. Pat. No. 7,791,788, assigned to the assignee of the present invention, strengthens the adhesion between the cured SPD emulsion and the substrates by modifying the polymer that constitutes the continuous phase of the SPD emulsion. U.S. Pat. No. 7,920,321, also assigned to the assignee of the present invention, describes the incorporation of overcoatings on the conductive substrates that enhance the adhesion of the cured SPD emulsion to said substrate. However, the application of adhesive promoting overcoatings increases the cost of the conductive coated substrates and, in some cases, the addition of the overcoating causes a reduction in the ΔT of the resulting SPD film.

The adhesion or peel strength of the bond between the conductive electrode and the cured layer of SPD emulsion for each of the SPD films made with the PEDT conductive polymer coated substrate and the standard ITO coated substrate were measured with the Shimadzu Trapezium 2 EZ-S Test system, manufactured by the Shimadzu Corporation, Kyoto, Japan. The tested specimen was prepared as follows:

The SPD film sample was cut into a 120 mm×25 mm (length×width) strip. A top portion of each of the outer opposed surfaces of each specimen was folded in opposite directions, i.e., apart from one another to form a T-shape along both top edges. The clamping grips of the EZ-S Test system were then used to grip the specimens to be tested along the opposed T-shaped edges. The instrument was then operated to peel the specimen apart and record the peeling strength at a pre-determined grip head moving speed (crosshead speed). The unit of peel strength is in Newtons per 25 mm width (N/25 mm). For comparison with peel strengths disclosed in the scientific literature, the width number in Table 2 should be converted to match the width set forth in the literature value(s), e.g., in Newtons per meter. Table 2 below presents detailed sample information and test results.

TABLE 2

| | Adhesion Avg. |
|---|---|
| Substrate ID | (N/25 mm) |
| Control ITO (7 mil PET, | 0.44 |
| Resistivity = 300 Ω/square) | |
| CLE1 (7 mil PET, Resistivity = | 1.46 |
| 150 Ω/square) | |
| CLE2 (5 mil PET, Resistivity = | 1.60 |
| 250 Ω/square) | |
| CTR4C-KB10 (5 mil PET, | 1.50 |
| Resistivity = 400 Ω/square) | |

The data contained in Table 2 shows that the adhesion of the cured SPD emulsion to the transparent conductive coatings is approximately four times higher when a PEDT conductive polymer is used to form the transparent conductive coating, compared to a standard ITO conductive-coated substrate.

Thus, as demonstrated by the values set forth in Tables 1 and 2, the use of PEDT conductive polymer-coated substrates instead of ITO-coated substrates for SPD films leads to comparable optical performance and improved adhesion.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A suspended particle device (SPD) film, said film comprising a pair of opposed, spaced apart cell walls, a cured emulsion between the cell walls, and electrode means located upon at least a portion of an interior surface of said cell walls, said cured emulsion having droplets of a liquid light valve suspension, with a plurality of particles dispersed in the liquid suspending medium, distributed within a cured polymer matrix material,
wherein the electrode means comprises a substantially transparent coating upon both said cell walls, said coating constituted of a composition comprising a polythiophene-based conductive polymer, and wherein an adhesion value of adhesive strength between the cured emulsion and the coating is at least 1.46 N/25 mm.

2. The film according to claim 1 wherein, the coating composition comprises, in addition to said polythiophene-based conductive polymer, at least one solvent and at least one binder.

3. The film according to claim 1, wherein the polythiophene-based conductive polymer is a polyethylene dioxythiophene (PEDT) polymer.

4. The film according to claim 3, wherein the PEDT polymer is doped with polystyrene sulfonate.

5. The film according to claim 2, wherein the at least one solvent is selected from the group consisting of an alcohol organic solvent, an amide organic solvent and an aprotic dipolar solvent.

6. The film according to claim 2, wherein the at least one binder is selected from the group consisting of melamine resin, polyester, polyurethane, polyacryl resin and alkoxysilane.

7. The film according to claim 1, wherein the cell walls are made from glass, plastic or a glass-plastic laminate.

8. The film according to claim 1 wherein the film comprises, in order:
(a) a first sheet of polyethylene terephthalate plastic;
(b) a first substantially transparent coating of said polythiophene-based conductive polymer upon at least a portion of an inner surface of said first sheet of polyethylene terephthalate plastic;
(c) a layer of cured SPD emulsion;
(d) a second substantially transparent coating of said polythiophene-based conductive polymer upon at least a portion of an inner surface of a second sheet of polyethylene terephthalate plastic; and
(e) a second sheet of polyethylene terephthalate plastic.

9. The film according to claim 1, wherein the film is laminated with at least one selected from the group consisting of adhesive film, glass and a thicker transparent plastic sheet.

10. The film according to claim 1, wherein a conductive material is connected to the electrode means such that the conductive material extends beyond an outer boundary of said film for connection to a suitable voltage source.

11. The film according to claim 1 in the form of a window, the electrode means and the cell walls being transparent.

12. A method for increasing adhesion between a cured suspended particle device emulsion and electrode means in a suspended particle device (SPD) film, said film comprising a pair of spaced apart cell walls, a cured matrix polymer material between the cell walls and electrode means located upon at least a portion of an interior surface of said cell walls, said cured matrix polymer material having droplets of a liquid light valve suspension comprising a plurality of particles dispersed in the liquid suspending medium distributed within the matrix, wherein said method comprises:
providing, as said electrode means, a substantially transparent coating upon at least a portion of both said cell walls, said coating constituted of a composition comprising a polythiophene-based conductive polymer.

13. The method according to claim 12, wherein the coating composition comprises, in addition to said polythiophene-based conductive polymer, at least one solvent and at least one binder.

14. The method according to claim 12, wherein the polythiophene-based conductive polymer is a polyethylene dioxythiophene (PEDT) polymer.

15. The method according to claim 14, wherein the PEDT polymer is doped with polystyrene sulfonate.

16. The method according to claim 12, wherein the cell walls are made from glass, plastic or a glass-plastic laminate.

17. The method according to claim 12 wherein the film comprises, in order:
(a) a first sheet of polyethylene terephthalate plastic;
(b) a first substantially transparent coating of said polythiophene-based conductive polymer upon at least a portion of an inner surface of said first sheet of polyethylene terephthalate plastic;
(c) a layer of cured SPD emulsion;
(d) a second substantially transparent coating of said polythiophene-based conductive polymer upon at least a portion of an inner surface of a second sheet of polyethylene terephthalate plastic; and
(e) a second sheet of polyethylene terephthalate plastic.

18. The method according to claim 12, which further comprises laminating the film with at least one selected from the group consisting of adhesive film, glass and a thicker transparent glass sheet.

19. The method according to claim 12, which further comprises connecting a conductive material to the electrode means such that the conductive material extends beyond an outer boundary of said film for connection to a suitable voltage source.

20. The method according to claim 12, further comprising producing the light valve in the form of a window, the electrode means and the cell walls being transparent.
